(19) United States
(12) Patent Application Publication
(10) Pub. No.: US 2026/0036995 A1
(43) Pub. Date: Feb. 5, 2026

(54) METHODS FOR OPTIMIZING PATH PLANNING FOR AGRICULTURAL VEHICLES

(71) Applicant: Sabanto, Inc., Itasca, IL (US)

(72) Inventors: Naveen Krishnaraj, Franklin, TN (US); Michael Joseph Lyons, Spring Hill, TN (US)

(73) Assignee: Sabanto, Inc., Itasca, IL (US)

(21) Appl. No.: 19/285,124

(22) Filed: Jul. 30, 2025

Related U.S. Application Data
(60) Provisional application No. 63/678,177, filed on Aug. 1, 2024.

(51) Int. Cl. G05D 1/644; G05D 105/15; G05D 107/20; G05D 109/10; G06N 10/60

(52) U.S. Cl. CPC G05D 1/644; G06N 10/60; G05D 2105/15; G05D 2107/21; G05D 2109/10

(57) ABSTRACT

Methods for optimizing path planning for agricultural vehicles are provided. In one embodiment, a field is defined, passes completely covering the field are created, the ends of each pass are transformed into nodes, distance and time matrices for the nodes are computed, and an optimization problem incorporating the time and distance matrices, agricultural constraints, and time window requirements is formulated. Prior to solving the optimization problem, verification that a feasible solution to the optimization problem exists is performed, and constraints are adjusted if a feasible solution does not exist. The optimization problem may be solved using a quantum annealing process to achieve an optimized route that performs well in an agricultural setting.

### CROSS-REFERENCE TO RELATED APPLICATIONS

This application claims priority to U.S. Provisional Patent Application No. 63/678,177, filed on Aug. 1, 2024, the entirety of which is hereby incorporated herein by reference.

### FIELD OF THE INVENTION

This invention relates generally to the operation of an agricultural vehicle. In particular, this invention provides methods for optimizing path planning algorithms for guiding operation of one or more agricultural vehicles.

### BACKGROUND OF THE INVENTION

Suboptimal path planning in the context of agricultural vehicles adversely and directly impacts efficiency, fuel consumption, and overall productivity in farming operations. Traditional path planning methods struggle with the dynamically changing environment of agriculture where variables such as varying and irregular field shapes, varying field sizes, diverse terrain types, and varying field operations complicate the path planning process. Time scheduling requirements also complicate path planning. For example, tasks such as planting, irrigating, and harvesting must occur within specific time windows for optimal results. Another complicating factor is scalability and multi-vehicle coordination. Large farms with multiple autonomous tractors require integrated scheduling and routing to prevent inefficiencies and overlapping routes. Further, existing solutions do not leverage state-of-the-art generative AI or Large Language Mode (LLM) capabilities, which can dynamically reason about constraints, integrate real-world data, generate viable solutions under uncertainty. and offer problem decomposition strategies.

Existing path planning approaches include greedy algorithms and heuristics. A greedy algorithm is any algorithm that follows the problem-solving heuristic of making the locally optimal choice at each stage. Greedy algorithms and heuristics provide quick solutions, but often fall short in terms of optimality and computational efficiency. They can easily become trapped in local optima, leading to suboptimal path planning that does not take into account the entirety of the field or changing conditions.

Another existing path planning approach is classical Vehicle Routing Problem (VRP) solvers. The VRP is a combinatorial optimization and integer programming problem which asks “What is the optimal set of routes for a fleet of vehicles to traverse in order to deliver to a given set of customers?” While VRP solvers are designed to find efficient routes and schedules for multiple vehicles, classical VRP solvers are not well-equipped to handle the unique constraints and dynamic changes inherent in agricultural settings.

Genetic algorithms and simulated annealing are more sophisticated approaches that simulate natural or physical processes to explore the solution space. However, they require extensive computation time, especially as the scale of the problem increases, mostly growing exponentially, which makes them less practical for real-time applications in large agricultural environments.

Grid-based and A* algorithms are another path planning approach. While useful in static and well-defined environments, these algorithms do not adapt well to the complex and changing nature of agricultural fields. They can be inefficient in terms of computation time and resource use, especially over large areas with diverse terrain.

Therefore, new path planning methods that can rapidly process large amounts of data and adapt to changing conditions in real-time are desired.

Another problem that exists with existing path planning methods for agricultural vehicles is inefficiencies in how the order of passes (i.e., the order in which the passes are traversed by the agricultural vehicles) is determined. This is a crucial aspect of vehicle path planning that is often overlooked. Existing path planning techniques, including those based on the semi-greedy algorithms and rule-based systems, primarily cater to standard navigation scenarios and fail to adequately address the unique requirements of agricultural settings, such as irregular field shapes, diverse terrain types and time scheduling requirements. Consequently, this leads to suboptimal routing, inefficient use of resources, and increased operational times, significantly affecting the overall productivity and sustainability of farming operations. General VRP solutions are typically designed for urban and suburban contexts, and these solutions lack the flexibility and adaptability required for the dynamic and varied agricultural environment. Many systems do not offer the needed flexibility to handle different field shapes, sizes, terrain types and time scheduling requirements effectively. Their limited scalability restricts their usefulness in more extensive or complex farming operations.

### SUMMARY OF THE INVENTION

In accordance with various embodiments of the invention, methods for optimizing path planning for agricultural vehicles are provided. In one embodiment, a method for optimizing a route for execution by a system that controls one or more agricultural vehicles involves defining an area of land to be worked by the one or more agricultural vehicles; creating a plurality of passes that completely cover the area of land, wherein each pass comprises a first end, which may serve as the starting point or the ending point of the pass, and a second end, which may serve as the starting point or the ending point of the pass; transforming each first end and each second end of each of the plurality of passes into a plurality of nodes; connecting the plurality of nodes to create one or more possible routes with Dubins paths or other possible routes; computing a distance matrix by calculating distances between every possible pair of nodes for each of the one or more possible routes; computing a time matrix by calculating times required to travel between every possible pair of nodes for each of the one or more possible routes; applying constraints which include constraints configured to ensure that each of the plurality of passes is worked exactly once by the one or more agricultural vehicles, constraints configured to ensure that time window requirements are met, and any other scheduling, resource, or capacity constraints; formulating a non-convex optimization problem incorporating the distance matrix, the time matrix, the constraints, and the time window requirements, the non-convex optimization problem having one or more solutions; determining that a feasible solution to the non-convex optimization problem exists; and solving the non-convex optimization problem using quantum annealing for agricultural vehicle routing to create an optimized route for controlling the one or more agricultural vehicles.

In another embodiment, a method for optimizing a route for execution by a system that controls one or more agricultural vehicles may involve defining an area of land to be worked by the one or more agricultural vehicles; creating a plurality of passes that completely cover the area of land, wherein each pass comprises a first end, which may serve as the starting point or ending point of the pass, and second end, which may serve as the starting point or ending point of the pass; transforming each first end and each second end of each of the plurality of passes into a plurality of nodes; connecting the plurality of nodes to create one or more possible routes; computing a distance matrix by calculating distances between every possible pair of nodes for each of the one or more possible routes; computing a time matrix by calculating times required to travel between every possible pair of nodes for each of the one or more possible routes; applying constraints which include constraints configured to ensure that each of the plurality of passes is worked exactly once by the one or more agricultural vehicles, constraints configured to ensure that time window requirements are met, and any other scheduling, resource, or capacity constraints; formulating a non-convex optimization problem incorporating the distance matrix, the time matrix, the constraints, and the time window requirements, the non-convex optimization problem having one or more solutions; determining that a feasible solution to the non-convex optimization problem exists; and solving the non-convex optimization problem to create an optimized route for controlling the one or more agricultural vehicles.

In another embodiment, a method for optimizing a route for execution by a system that controls one or more agricultural vehicles involves defining an area of land to be worked by the one or more agricultural vehicles; creating a plurality of passes that completely cover the area of land, wherein each pass comprises a first end, which may serve as the starting point or the ending point of the pass, and a second end, which may serve as the starting point or the ending point of the pass; transforming each first end and each second end of each of the plurality of passes into a plurality of nodes; connecting the plurality of nodes to create one or more possible routes with Dubins paths or other possible routes; computing a distance matrix by calculating distances between every possible pair of nodes for each of the one or more possible routes; computing a time matrix by calculating times required to travel between every possible pair of nodes for each of the one or more possible routes; applying constraints which include constraints configured to ensure that each of the plurality of passes is worked exactly once by the one or more agricultural vehicles, constraints configured to ensure that time window requirements are met, and any other scheduling, resource, or capacity constraints; formulating a non-convex optimization problem incorporating the distance matrix, the time matrix, the constraints, and the time window requirements, the non-convex optimization problem having one or more solutions; determining that a feasible solution to the non-convex optimization problem exists; and solving the non-convex optimization problem using Grover's Algorithm to create an optimized route for controlling the one or more agricultural vehicles.

In another embodiment, a method for generative AI-enhanced vehicle routing problem involve defining an area of land to be worked by the one or more agricultural vehicles; creating a plurality of passes that completely cover the area of land, wherein each pass comprises a first end, which may serve as the starting point or ending point of the pass, and second end, which may serve as the starting point or ending point of the pass; transforming each first end and each second end of each of the plurality of passes into a plurality of nodes; connecting the plurality of nodes to create one or more possible routes; computing a distance matrix by calculating distances between every possible pair of nodes for each of the one or more possible routes; computing a time matrix by calculating times required to travel between every possible pair of nodes for each of the one or more possible routes; generating an initial route, performing LLM-driven refinement of the initial path, checking for a valid solution and re-prompting the LLM if the solution is invalid, performing heuristic meta-optimization, and finalizing the solution to create an optimized route for controlling the one or more agricultural vehicles.

### BRIEF DESCRIPTION OF DRAWINGS

Having thus described the invention in general terms, reference will now be made to the accompanying drawings, which are not necessarily drawn to scale, and wherein:

FIG. 1 illustrates a typical agricultural vehicle and implement arrangement.

FIG. 2 illustrates a method for quantum optimization of path planning for agricultural vehicles in accordance with an embodiment of the invention.

FIG. 3 illustrates a quantum annealing algorithm in accordance with an embodiment of the invention.

FIG. 4 illustrates a workflow for a quantum annealing algorithm in accordance with an embodiment of the invention.

FIG. 5 illustrates a path planning algorithm in accordance with an embodiment of the invention.

FIG. 6 illustrates a method for optimizing path planning in the field of agricultural navigation using Grover's Algorithm in accordance with an embodiment of the invention.

FIG. 7 illustrates a method for implementation of Grover's Algorithm in an agricultural setting in accordance with an embodiment of the invention.

FIG. 8 illustrates an overview of Grover's Algorithm in accordance with an embodiment of the invention.

FIG. 9 illustrates a three-qubit Grover's Algorithm in accordance with an embodiment of the invention.

FIG. 10 illustrates a method for generative AI-enhanced vehicle routing problem in accordance with an embodiment of the invention.

### DETAILED DESCRIPTION OF THE INVENTION

Some embodiments of the present invention will now be described more fully hereinafter with reference to the accompanying drawings, in which some, but not all, embodiments of the invention are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus are not shown in one or more of the figures for clarity and to facilitate explanation of embodiments of the present invention.

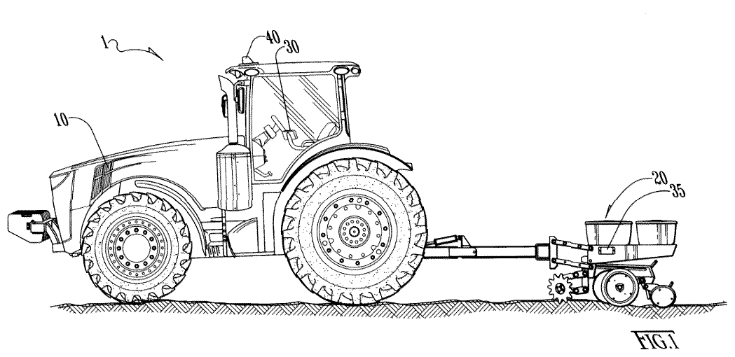

In accordance with one embodiment, FIG. 1 illustrates a typical arrangement 1 of an agricultural vehicle 10. The agricultural vehicle may comprise a tractor, sprayer, combine, or other vehicle capable of performing agricultural work operations. The agricultural vehicle 10 may have an implement 20 coupled to it. Implement 20, if present, is coupled to the vehicle 10 using either a drawbar or three-point hitch. The agricultural vehicle 10 may be a manned, semi-autonomous, or autonomous vehicle. Agricultural vehicle 10 may alternatively be called vehicle 10 or tractor 10 without departing from the scope of the disclosure.

A monitor 30 mounted on the vehicle 10 communicates with various systems of vehicle 10 and implement 20. For example, monitor 30 is configured to receive and transmit signals to the CAN bus, engine control unit (ECU), and other systems of vehicle 10. Monitor 30 also communicates with a GPS unit 40 mounted to vehicle 10. Monitor 30 may be a tablet, laptop, or commercially available display for use in agricultural vehicles. GPS unit 40 is configured to receive satellite signals indicating the precise location of the GPS unit 40 and vehicle 10. Software running on monitor 30 is configured to control many aspects of the arrangement 1. For example, using location information from the GPS unit 40, software running on monitor 30 can control the movement of vehicle 10, raising and lowering of the implement 20, application rates performed by the implement 20, or any other aspect of controlling the implement 20 to perform a work operation. Software running on monitor 30 is also configured to record data regarding the operation of the vehicle 10 and implement 20, including the path driven by vehicle 10, application rates performed by the implement 20 throughout each worked field, and data generated by various sensors mounted to the vehicle 10 or implement 20.

A microprocessor 35 mounted on implement 20 is electronically connected to any sensors mounted on the implement 20. Microprocessor 35 is configured to receive signals from any attached sensors and perform processing to determine if sensor readings are within acceptable ranges. Microprocessor 35 is also configured to receive and transmit signals to the monitor 30. If microprocessor 35 detects an abnormal sensor reading, then that information is transmitted to monitor 30, and the vehicle 10 or implement 20 can be stopped or other remediation measures can be taken. Throughout this disclosure, any processing of sensor signals may be performed on either monitor 30 or microprocessor 35. In a typical implement 20, simple processing tasks are performed by microprocessor 35, and readings and results captured by microprocessor 35 are communicated to monitor 30 for further processor or other action.

One or more of the path plans described in the various embodiments of the disclosed methods may be created, modified, or stored on board the vehicle 10, implement 20, for example on monitor 30 or microprocessor 35. One or more path plans described in the disclosed methods may alternatively be created, modified, or stored in an off-board environment such as a separate computer or server where relevant information is processed, stored, or otherwise accessed.

A method 100 for path planning in the field of agricultural navigation using a quantum computing based Vehicle Routing Problem (VRP) solver is disclosed. The method 100 uses a quantum annealing algorithm 200 and quantum optimization for advanced path planning. By leveraging these quantum techniques, the method 100 significantly enhances the efficiency and effectiveness of planning routes for agricultural vehicles, surpassing the capabilities of traditional optimization methods. The method 100 may alternatively be referred to as the solver 100 or the VRP solver 100 without departing from the scope of the disclosure. Method 100 may be used to plan paths for a single agricultural vehicle 10 or multiple agricultural vehicles 10 that work together to complete a work operation in a field.

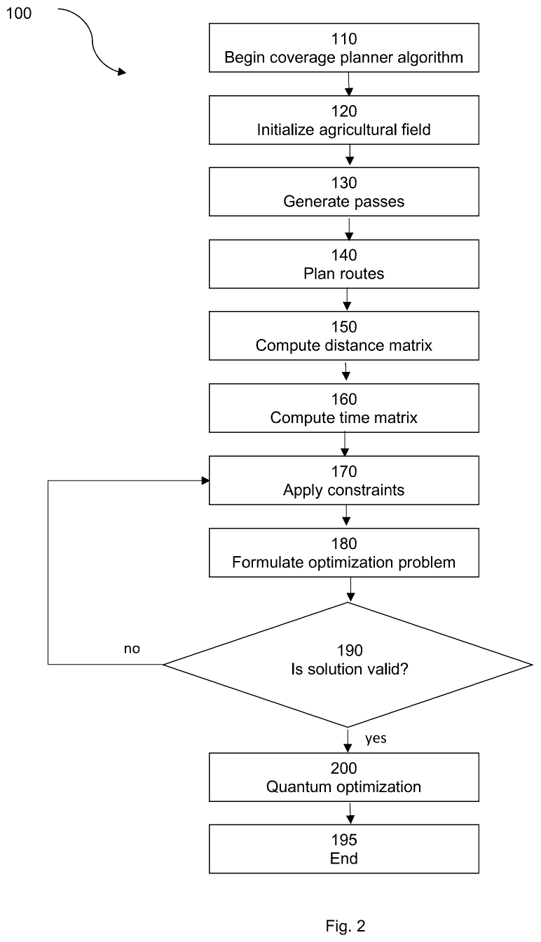

The method 100 involves translating complex agricultural path planning problems into the quantum domain, enabling simultaneous evaluation of numerous potential paths and the efficient determination of optimal routes under various operational conditions. As shown in FIG. 2, a method 100 for path planning using a quantum computing-based VRP solver begins at step 110 with the beginning of the coverage planner algorithm tailored for agricultural needs.

The method 100 proceeds to step 120 in which a field is created. The agricultural field to be covered by the method 100 is initialized, taking into account its unique shapes and sizes. Initializing the agricultural field to be covered at step 120 involves defining the boundaries of a working area of a field. The working area may be an entire field or a portion of a field. Defining the working area may be performed using several methods. For example, the agricultural field may be initialized by entering into path planning software the geospatial coordinates of points that, when connected, form the boundaries of the field, drawing the boundaries on a map using geospatial software, driving the perimeter of the working area and recording GPS coordinates of points defining the boundaries using the GPS unit 40, exporting geometries from other (FMIS) systems and importing those geometries into path planning software, or another method may be used without departing from the scope of the disclosure.

The method 100 then proceeds to step 130 in which passes are generated. The passes are paths that the agricultural vehicle 10 and implement 20 will travel over during the work operation. Step 130 involves creating passes that comprehensively cover the entire field that was created at step 120, considering possible directions to accommodate field geometry. Each pass has a first end and a second end. The first end and the second end of the pass can be both a starting point and an ending point of the pass. In other words, the first end could serve as the starting point of the pass and the second end the ending point of the pass, or the second end could serve as the starting point of the pass and the first end could serve as the ending point of the pass, and either of these directions of travel are valid.

The method 100 then proceeds to step 140 in which routes are planned. Step 140 involves transforming each end of a pass created at step 130 into a ‘node’ akin to a ‘city’ in traditional VRP, and planning routes connecting these nodes with Dubins paths or other proprietary shapes, considering specific parameter of vehicle 10 and implement 20 such as turn radius, speed, implements 20 on the agricultural vehicle 10, time to raise the implement 20, and time to lower the implement 20.

The method 100 proceeds to step 150 in which a distance matrix is computed. To calculate the distance matrix, calculate the distance between every possible pair of nodes (ends of passes) created at step 140 to include direct distances for each pass, adapting this matrix to reflect the true distances encountered in agricultural settings due to varying terrains and pass lengths.

At step 160, the time matrix is computed. Computing the time matrix at step 160 involves calculating the time required to travel between every possible pair of nodes (ends of passes), taking into account the direct distances for each pass and the velocity of the agricultural vehicle 10.

At step 170, several constraints of various types are applied. The constraints may include time window constraints, constraints to ensure complete coverage of the field, and any other scheduling, resource, or capacity constraints. The method 100 incorporates time-window constraints essential for the sequential execution of various farming tasks such as tillage, planting, weeding, harvesting etc. By optimizing the order and timing of field operations, the solution provided by the method 100 ensures that each activity is performed within its ideal timeframe. Applying constraints at step 170 also involves implementing constraints to ensure that each pass is worked exactly once, integrating custom time windows based on client requirements for time-sensitive agricultural operations, and incorporating fuel capacity constraints to address the operational limits of each vehicle 10. While each pass must be worked exactly once during the work operation, meaning that the field operation being performed is only done once to a particular pass, the optimizer may choose to traverse a pass more than once. For a planting operation, the constraints may include the amount of seed held by the planter/implement 20. For a spraying operation, the constraints may include the amount of chemicals stored in the sprayer/implement 20. Any similar scheduling, resource, or capacity constraints may be implemented at step 170 without departing from the scope of the disclosure.

At step 180, an optimization problem is formulated. To formulate an optimization problem at step 180, redefine the problem as a multi-vehicle 10, non-convex optimization. Establish the number of vehicles 10 and their routes, incorporating the distance matrix computed at step 150, the time matrix computed at step 160, the various constraints applied at step 170, and custom time windows.

At step 190, check for a valid solution. Checking for a valid solution at step 190 involves verifying the existence of a feasible routing solution that meets all the agricultural and logistical constraints. If yes, a valid solution exists, and the method proceeds to step 200 in which the optimization problem is solved. If no, then a valid solution does not exist, and the method returns to step 170 to adjust the constraints.

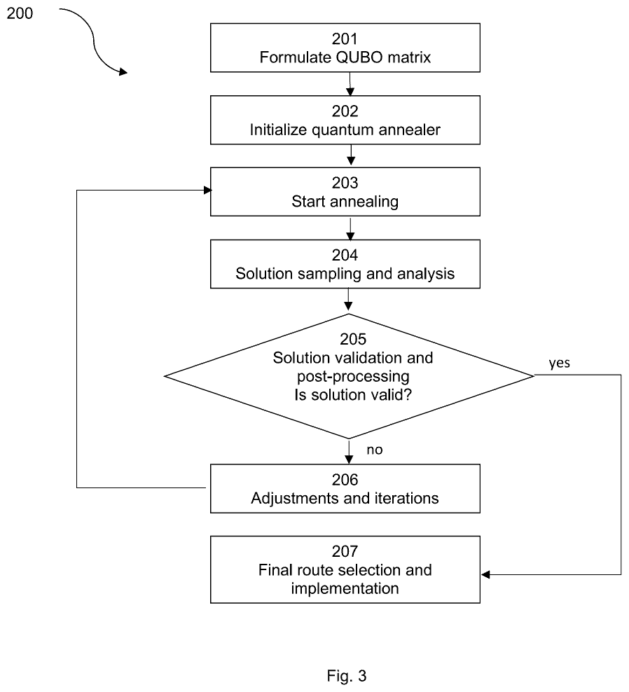

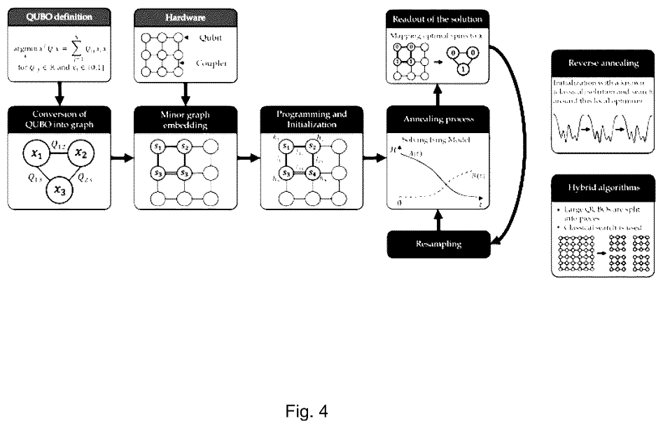

At step 200, quantum optimization is performed. The quantum optimization algorithm 200 may alternatively be referred to as the quantum annealing algorithm 200, quantum annealing subroutine 200, quantum optimization 200, quantum based non-convex programming or method 200 without departing from the scope of the disclosure. The steps of the quantum annealing algorithm 200 are shown in FIGS. 3 and 4, and are subsequently described in this disclosure.

At step 210, the method 100 ends. Route planning is concluded with the optimized solution, and the algorithm 100 is ended.

### Quantum Optimization Algorithm 200

The process for solving Quadratic Unconstrained Binary Optimization (QUBO), this may also be referred to as Quantum Annealing 200 problems using quantum computing hardware. It starts with defining the QUBO problem and converting it into a graph representation. This graph is then translated into a minor embedding that maps the problem onto the hardware's qubit topology and coupler connections. The next steps involve programming and initializing the qubits and couplers with the problem parameters. The annealing process then solves the Ising model representation of the problem, which aims to find the optimal configuration that minimizes the energy of the system. This involves a combination of quantum annealing and classical search around the local optimum. The solution is read out by measuring the final states of the qubits, which correspond to the binary variables in the original QUBO problem. Hybrid algorithms that split large QUBOs into pieces and use classical search are mentioned as an approach for tackling problems that exceed the capacity of the quantum hardware. Finally, the solution is reverse annealed to further refine and improve the quality of the result.

In the agricultural context, a quantum annealing algorithm 200 for optimizing path planning of an agricultural vehicle 10 is applied to minimize a specially designed cost function that accounts for the unique aspects of agricultural path planning. This cost function incorporates distances and time between points and field-specific constraints, with the quantum annealing algorithm 200 enabling the exploration of various path configurations to find the one that minimizes this function, ensuring optimal vehicle paths. The quantum annealing algorithm 200 involves mapping agricultural data and requirements into quantum states and defining the optimization problem for quantum processing. The quantum annealing algorithm 200 evaluates multiple potential vehicle 10 paths in parallel, considering real-world constraints, to determine the most efficient routing solutions quickly.

As shown in FIGS. 3 and 4, a quantum annealing algorithm 200 begins with step 201, formulating the QUBO matrix. Formulating the QUBO matrix at step 201 involves, based on the agricultural context, encoding the vehicle 10 routing problem into a QUBO format, where the cost function incorporates factors like distance, time and agricultural constraints. Variables are used to represent the routing choices for each vehicle 10, with constraints ensuring each vehicle 10 follows exactly one route from its start to end points. Segment weights are included to account for varying agricultural conditions affecting traversal difficulty and speed. Preferred and penalty routes are also considered.

At step 202, the quantum annealer is initialized. The QUBO matrix formulated at step 201 is loaded into the quantum annealer software. The quantum annealer software may be any commercially available quantum annealer software package. Initial parameters are set for the annealing process, ensuring all qubits are in a superposition state allowing for a comprehensive search of the solution space.

At step 203, the quantum annealing process is performed in which the system evolves, exploring various configurations. Step 203 aims to minimize the objective function by altering the states of qubits, representing different routing options, to reach the lowest energy state corresponding to the optimal or near-optimal vehicle routing solution.

At step 204, solution sampling and analysis are performed. At the conclusion of the annealing at step 203, sample the resulting quantum states. Each state represents a potential solution to the routing problem. Evaluate these samples to find the one with the lowest associated energy level, indicating the optimal routing configuration under current conditions.

At step 205, solution validation and post-processing occurs. Each solution calculated at step 204 is validated. Step 205 involves ensuring that the selected solution meets all agricultural and routing constraints such as complete route coverage. The quantum-derived solution is adjusted and validated against real-world agricultural constraints, ensuring practical applicability.

At step 206, adjustments and iterations are performed. If the result of the validation at step 205 indicates that the solution is not feasible or optimal, adjust the parameters or constraints in the QUBO model and repeat the step 203 quantum annealing process. This iterative approach allows for refining the solution, accommodating dynamic changes in agricultural conditions or operational requirements.

Step 207 is final route selection and implementation. Once a valid and optimal solution is identified, translate the quantum solution into actionable routing paths for the vehicles 10. The resulting final route is returned to the main algorithm method 100, ready to be used for routing each vehicle 10.

Quantum annealing enables the solver to efficiently navigate vast solution spaces, rapidly identifying optimal or near-optimal solutions for vehicle 10 path planning. This technique is particularly suited for the complex and dynamic landscapes of agricultural fields, avoiding the local minima that often hinder classical algorithms. Quantum tunneling enables the disclosed methods to explore a vast solution space more effectively than traditional methods. While classical algorithms waste time navigating out of suboptimal solutions, quantum tunneling allows the disclosed methods to bypass these traps, leading directly to the global minimum or best possible solution. Quantum computing also allows optimization beyond the limits of classical algorithms. Quantum computing allows the solver to tackle multidimensional and dynamic optimization problems that classical computers find intractable, such as varying field geometries and complex constraints. The disclosed methods are designed for seamless integration with agricultural systems, facilitating an easy transition to quantum-based solutions and enhancing operational efficiency without disrupting existing workflows. The design of the disclosed methods ensures it can scale to accommodate any size of agricultural operation and adapt to various farming practices, making it a versatile tool across the agricultural industry. This approach transcends the limitations commonly associated with classical optimization methods, particularly in handling the complex, dynamic, and large-scale optimization problems inherent in modern agriculture.

### Method for Optimizing Sequencing and Scheduling of Passes 300

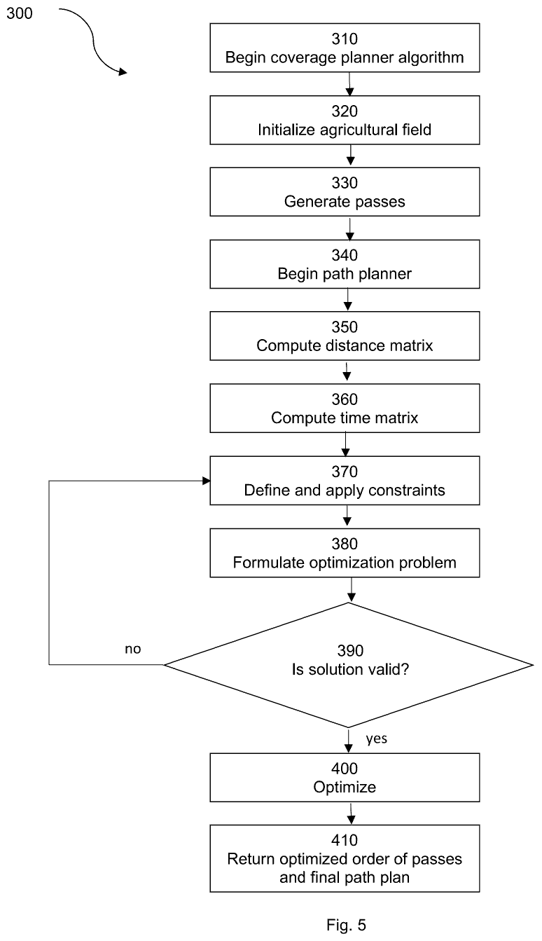

As shown in FIG. 5, a method 300 for optimizing sequencing and scheduling of passes is disclosed. The method 300 significantly advances route optimization for agricultural vehicles 10 by customizing traditional methods to fit the unique aspects of agricultural environments. This refined approach primarily concentrates on enhancing the sequence and scheduling of passes, which are key elements in the efficiency of agricultural operations, while also improving the overarching path planning framework. The mathematical framework of method 300 constructs an optimization model that aims at minimizing total distance, total time and operational costs while incorporating unique constraints pertinent to agriculture.

The method 300 for optimizing sequencing and scheduling of passes begins at step 310 with beginning the coverage planner algorithm tailored for agricultural needs.

The method proceeds to step 320 in which a field is created. The agricultural field to be covered by the method 300 is initialized, taking into account its unique shapes and sizes. Initializing the agricultural field to be covered at step 320 involves defining the boundaries of a working area of a field. The working area may be an entire field or a portion of a field. Defining the working area may be performed using several methods. For example, the agricultural field may be initialized by entering into path planning software the geospatial coordinates of points that, when connected, form the boundaries of the field, drawing the boundaries on a map using geospatial software, driving the perimeter of the working area and recording GPS coordinates of points defining the boundaries using the GPS unit 40, exporting geometries from other (FMIS) systems and importing those geometries into path planning software, or another method may be used without departing from the scope of the disclosure.

The method then proceeds to step 330 in which passes are generated. The passes are paths that the agricultural vehicle 10 and implement 20 will travel over during the work operation. Step 330 involves creating passes that comprehensively cover the entire field that was created at step 320, considering possible directions to accommodate field geometry.

The method then proceeds to step 340 in which routes are planned. Step 140 involves transforming each end of a pass created at step 130 into a ‘node’ akin to a ‘city’ in traditional VRP, and planning routes connecting these nodes with Dubins paths or other proprietary shapes, considering agricultural specifics like turn radius, speed, and implements 20 on the agricultural vehicle 10.

The method proceeds to step 350 in which a distance matrix is computed. To calculate the distance matrix, calculate the distance between every possible pair of nodes (ends of passes) created at step 340 to include direct distances for each pass, adapting this matrix to reflect the true distances encountered in agricultural settings due to varying terrains and pass lengths.

At step 360, the time matrix is computed. Computing the time matrix at step 360 involves calculating the time required to travel between every possible pair of nodes (ends of passes), taking into account the direct distances for each pass and the velocity of the agricultural vehicle 10.

At step 370, several constraints of various types are applied, reflecting the operational realities encountered by vehicle 10 during a work operation. The constraints may include time window constraints, constraints to ensure complete coverage of the field, and any other scheduling, resource, or capacity constraints. The method 300 incorporates time-window constraints essential for the sequential execution of various farming tasks such as tillage, planting, weeding, harvesting etc. By optimizing the order and timing of field operations, the solution provided by the method 300 ensures that each activity is performed within its ideal timeframe. Another type of constraint applied at step 370 involves ensuring that each pass is worked exactly once, which is represented mathematically to prevent redundant coverage and guarantee total field service. While each pass must be worked exactly once during the work operation, meaning that the field operation being performed is only done once to a particular pass, the optimizer may choose to traverse a pass more than once. Another type of constraint applied at step 370 involves applying fuel constraints, including fuel capacity limitations ensuring that planned routes do not exceed the fuel capacity of the vehicles 10, necessitating returns to a depot or fuel station. For a planting operation, the constraints may include the amount of seed held by the planter/implement 20. For a spraying operation, the constraints may include the amount of chemicals stored in the sprayer/implement 20. Any similar scheduling, resource, or capacity constraints may be implemented at step 170 without departing from the scope of the disclosure.

At step 380, an optimization problem is formulated. To formulate an optimization problem at step 380, redefine the problem as a multi-vehicle 10, non-convex optimization. Establish the number of vehicles 10 and their routes, incorporating the distance matrix computed at step 350, the time matrix computed at step 360, the various constraints applied at step 370, and custom time windows. The core of the optimization problem is the objective function. The objective function is formulated as one of the following four functions, and is selected based on the needs of the client and problem:

$$Minimize {\sum }_{-} ( i = 1 ) \hat{} n {\sum }_{-} ( j = 1 , j \neq i ) \hat{} n ( d\_ij * x\_ij + t\_ij * x\_ij )$$

$$or$$

$$Minimize {\sum }_{-} ( i = 1 ) \hat{} n {\sum }_{-} ( j = 1 , j \neq i ) \hat{} n ( w\_d * d\_ij * xij + w\_t * t\_ij * x\_ij )$$

$$or$$

$$Minimize {\sum }_{-} ( i = 1 ) \hat{} n {\sum }_{-} ( j = 1 , j \neq i ) \hat{} n ( d\_ij * x\_ij )$$

$$or$$

$$Minimize {\sum }_{-} ( i = 1 ) \hat{} n {\sum }_{-} ( j = 1 , j \neq i ) \hat{} n ( t\_ij * x\_ij )$$

where d_ij represents the distance between nodes i and j, t_ij represents the travel time from i to j, and x_ij is a binary variable indicating whether the path from i to j is included in the route of the vehicle 10 and w_t & w_d indicates the weight given to distance and time and typically w_t=1−w_d or vice versa.

At step 390, check for a valid solution: Checking for a valid solution at step 390 involves verifying the existence of a feasible routing solution that meets all the agricultural and logistical constraints. If yes, a valid solution exists, and the method proceeds to step 400 in which the optimization problem is solved. If no, then a valid solution does not exist, and the method returns to step 370 to adjust the constraints.

At step 400, optimization is performed. To solve the optimization problem at step 400, employ heuristic and meta-heuristic techniques, such as guided local search and simulated annealing. These methods start with a simplistic initial solution considering basic route logic and constraints, then iteratively improve this initial solution using a solver guided local search strategies and other techniques like simulated annealing to find more efficient routing combinations.

At step 410, the method 300 ends. Upon finding an optimized route plan, the method 300 finalizes these routes, ensuring they are aligned with the operational efficiencies, time requirements, and resource constraints of modern agricultural practices. The final paths are constructed based on the optimized order of passes; this from the start point to the end point of the plan. The optimized order of passes and final path plan are returned, and the complete path plan can then be implemented by the vehicle 10.

The method 300 adapts to the unique and static conditions of the agricultural environment; like variable field geometries and different terrain types, enhancing the effectiveness of route planning. This ensures that the path planning is specifically attuned to the complexities of farm landscapes. The method 300 also addresses the need for coordinated operation among multiple vehicles 10, managing individual vehicle 10 capacities such as fuel levels and workload limits. By optimizing routes and assignments for each vehicle 10, the system prevents overlapping routes and reduces unnecessary fuel usage, thus improving operational efficiency across multiple vehicles 10. Beyond route optimization, the method 300 is designed to integrate seamlessly with existing farm management systems. It ensures that path planning is in harmony with the overall operational schedule and farm practices, enhancing the coherence and efficiency of farm operations. The method 300 is scalable, suitable for different farm sizes and operational scopes. It can be integrated seamlessly with existing agricultural management systems, enhancing usability and adoption without the need for significant system overhauls. The method 300 enhances operational efficiency by minimizing the total distance traveled by all vehicles 10. This reduction not only decreases fuel consumption and wear and tear on equipment but also ensures that all areas of the field are adequately covered. The method 300 bridges the gap in agricultural path planning, delivering a solution that enhances operational efficiency and reduces resource consumption. This approach not only ensures that farming activities are executed within their optimal time frames but also improves the coordination and efficiency of vehicle 10 operations.

### Method for Optimizing Path Planning Using Grover's Algorithm 500

A method 500 for optimizing path planning in the field of agricultural navigation using Grover's Algorithm 550 is disclosed. The method 500 uses a quantum computing-based Vehicle Routing Problem (VRP) solver to the field of agriculture by using Grover's Algorithm 550 for advanced path planning. By leveraging these quantum techniques, the method 500 significantly enhances the efficiency and effectiveness of planning routes for agricultural vehicles, surpassing the capabilities of traditional optimization methods. The method 500 may alternatively be referred to as the solver 500 without departing from the scope of the disclosure. Method 500 may be used to plan paths for a single agricultural vehicle 10 or multiple agricultural vehicles 10 that work together to complete a work operation in a field.

Use of Grover's Algorithm 550 in the method 500 enables the solver 500 to efficiently handle vast solution spaces by leveraging amplitude amplification to find valid or optimal solutions. The method 500 is particularly suited for the complex and dynamic landscapes of agricultural fields, overcoming the local minima that often hinder classical algorithms. Quantum computing allows the solver 500 to tackle multidimensional and dynamic optimization problems that classical computers find intractable, such as varying field geometries and complex constraints. Designed for seamless integration, the solver 500 facilitates an easy transition to quantum-based solutions, enhancing operational efficiency without disrupting existing workflows. The design of the solver 500 ensures it can scale to accommodate any size of agricultural operation and adapt to various farming practices, making it a versatile tool across the agricultural industry.

In the agricultural context, Grover's Algorithm 550 can be employed to search through a structured or unstructured database of possible route configurations. The cost function (distance, time, and field-specific constraints) is used to mark all solutions that meet the thresholds or requirements (such as covering all passes exactly once, staying within fuel limits, etc.) Grover's amplitude amplification than raises the probability of sampling a valid, near-optimal path configuration.

The method 500 involves mapping agricultural data and requirements into quantum states and defining the route configurations as a “database” for Grover's search. The solver 500 evaluates multiple potential tractor paths in parallel, considering real-world constraints, to quickly determine the most efficient routing solutions.

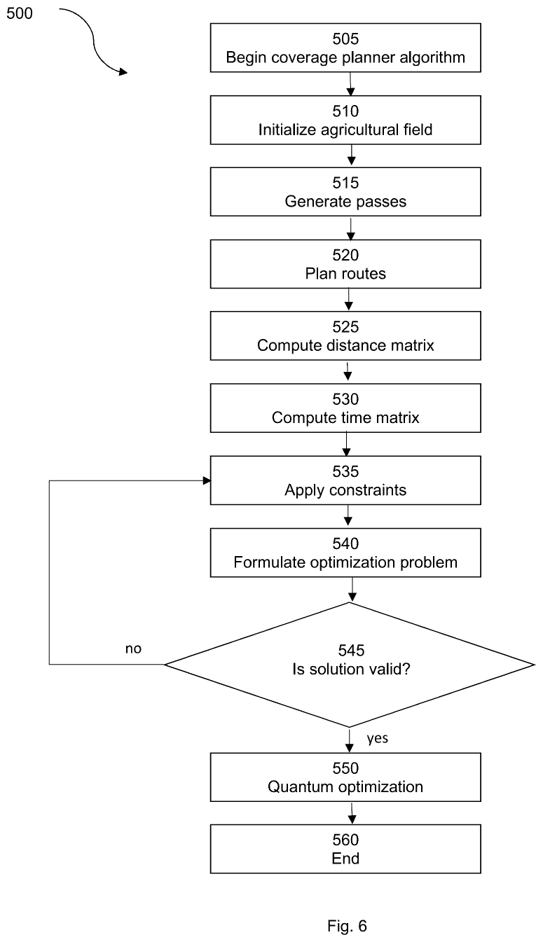

As shown in FIG. 6, a method 500 for optimizing path planning in the field of agricultural navigation using Grover's Algorithm 550 begins at step 505 with the beginning of the coverage planner algorithm tailored for agricultural needs.

The method 500 proceeds to step 510 in which a field is created. The agricultural field to be covered by the method 500 is initialized, taking into account its unique shapes and sizes. Initializing the agricultural field to be covered at step 510 involves defining the boundaries of a working area of a field. The working area may be an entire field or a portion of a field. Defining the working area may be performed using several methods. For example, the agricultural field may be initialized by entering into path planning software the geospatial coordinates of points that, when connected, form the boundaries of the field, drawing the boundaries on a map using geospatial software, driving the perimeter of the working area and recording GPS coordinates of points defining the boundaries using the GPS unit 40, exporting geometries from other (FMIS) systems and importing those geometries into path planning software, or another method may be used without departing from the scope of the disclosure.

The method 500 then proceeds to step 515 in which passes are generated. The passes are paths that the agricultural vehicle 10 and implement 20 will travel over during the work operation. Step 515 involves creating passes that comprehensively cover the entire field that was created at step 510, considering possible directions to accommodate field geometry. Each pass has a first end and a second end. The first end and the second end of the pass can be both a starting point and an ending point of the pass. In other words, the first end could serve as the starting point of the pass and the second end the ending point of the pass, or the second end could serve as the starting point of the pass and the first end could serve as the ending point of the pass, and either of these directions of travel are valid.

The method 500 then proceeds to step 520 in which routes are planned. Step 520 involves transforming each end of a pass created at step 515 into a ‘node’ akin to a ‘city’ in traditional VRP, and planning routes connecting these nodes with Dubins paths or other proprietary shapes, considering specific parameter of vehicle 10 and implement 20 such as turn radius, speed, implements 20 on the agricultural vehicle 10, time to raise the implement 20, and time to lower the implement 20.

The method 500 proceeds to step 525 in which a distance matrix is computed. To calculate the distance matrix, calculate the distance between every possible pair of nodes (ends of passes) created at step 520 to include direct distances for each pass, adapting this matrix to reflect the true distances encountered in agricultural settings due to varying terrains and pass lengths.

At step 530, the time matrix is computed. Computing the time matrix at step 530 involves calculating the time required to travel between every possible pair of nodes (ends of passes), taking into account the direct distances for each pass and the velocity of the agricultural vehicle 10.

At step 535, several constraints of various types are applied. The constraints may include time window constraints, constraints to ensure complete coverage of the field, and any other scheduling, resource, or capacity constraints. The method 500 incorporates time-window constraints essential for the sequential execution of various farming tasks such as tillage, planting, weeding, harvesting etc. By optimizing the order and timing of field operations, the solution provided by the method 500 ensures that each activity is performed within its ideal timeframe. Applying constraints at step 535 also involves implementing constraints to ensure that each pass is worked exactly once, integrating custom time windows based on client requirements for time-sensitive agricultural operations, and incorporating fuel capacity constraints to address the operational limits of each vehicle 10. While each pass must be worked exactly once during the work operation, meaning that the field operation being performed is only done once to a particular pass, the optimizer may choose to traverse a pass more than once. For a planting operation, the constraints may include the amount of seed held by the planter/implement 20. For a spraying operation, the constraints may include the amount of chemicals stored in the sprayer/implement 20. Any similar scheduling, resource, or capacity constraints may be implemented at step 535 without departing from the scope of the disclosure.

At step 540, an optimization problem is formulated. To formulate an optimization problem at step 540, redefine the problem as a multi-vehicle 10, non-convex optimization. Establish the number of vehicles 10 and their routes, incorporating the distance matrix computed at step 525, the time matrix computed at step 530, the various constraints applied at step 535, and custom time windows.

At step 545, check for a valid solution. Checking for a valid solution at step 545 involves verifying the existence of a feasible routing solution that meets all the agricultural and logistical constraints. If yes, a valid solution exists, and the method proceeds to step 550 in which the optimization problem is solved, specifically Grover's Algorithm 550 is implemented for agricultural vehicle routing. If no, then a valid solution does not exist, and the method returns to step 535 to adjust the constraints.

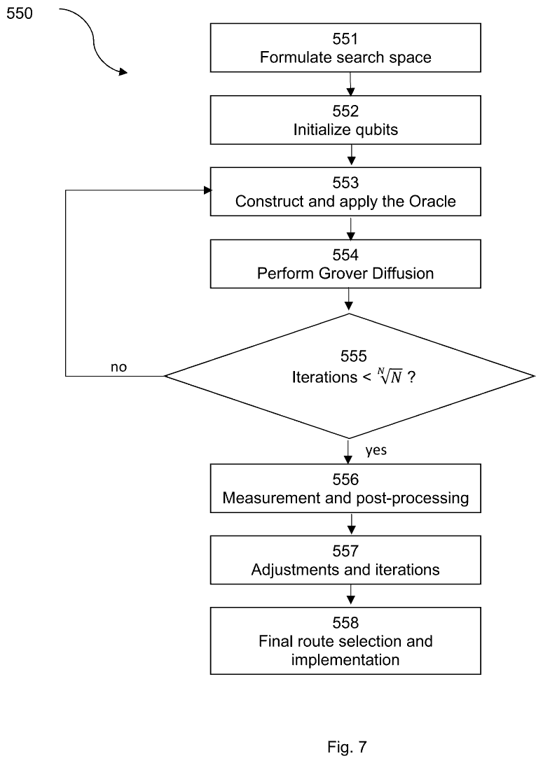

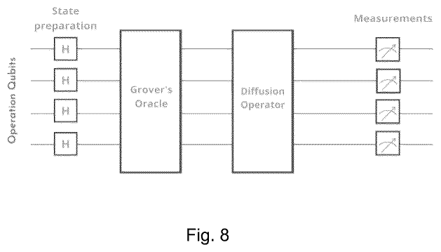

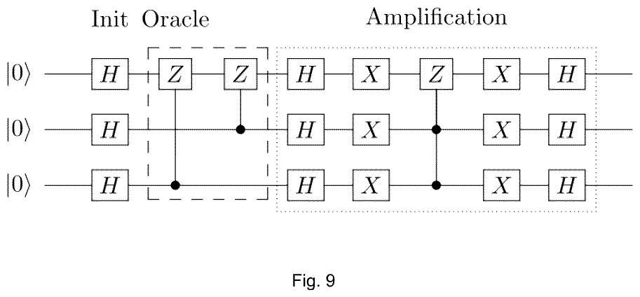

At step 550, quantum optimization is performed by implementing Grover's Algorithm for agricultural vehicle routing. The quantum optimization algorithm 550 may alternatively be referred to as Grover's Algorithm 550, Grover's Algorithm implementation 550, quantum optimization 550, or method 550 without departing from the scope of the disclosure. The steps of the Grover's Algorithm implementation 550 are shown in FIGS. 7-9, and are subsequently described in this disclosure.

At step 560, the method 500 ends. Route planning is concluded with the optimized solution, and the algorithm 500 is ended.

By substituting quantum annealing with Grover's Algorithm while keeping the core logic of mapping the agricultural VRP into a quantum domain, the method 500 delivers a fast, efficient pathway to identifying feasible or optimal routes for autonomous agricultural operations.

### Quantum Optimization Using Grover's Algorithm 550

As shown in FIGS. 7-9, implementation of Grover's Algorithm 550 begins with step 551, formulating the search space. Formulating the search space at step 551 involves, based on the agricultural context, encoding all potential routing choices (permutation of nodes, feasible arcs, etc.) for the vehicle 10 as a database. The cost function for implementation of step 551 incorporates factors such as distance, time, and agricultural constraints into a marking or Oracle function that identifies which route configurations meet desired thresholds or are sufficiently optimal.

At step 552, qubits are initialized. A uniform superposition is created over all route configurations. Each qubit or set of qubits corresponds to a portion of the route decision.

At step 553, the Oracle is constructed and applied. Constructing the Oracle at step 553 involves designing an Oracle that marks valid or better-than-threshold solutions by flipping a special qubit if the candidate route satisfies constraints. Such constraints include covering every pass once, operating within feasible time windows, operating within fuel limits, etc. The Oracle ensures that route configurations violating constraints are not marked.

At step 554, Grover Diffusion or amplitude amplification is performed. After marking valid states at step 553, the diffusion operator is applied to amplify the amplitudes of those marked states. Performance of step 554 systematically increases the probability of measuring valid and potentially optimal solutions.

At step 555, steps 553 and 554 are repeated √(N&N) times, where N is the number of possible route configurations. This iteration at step 555 maximizes the probability of sampling a valid or optimal route. This ensures that the amplitude amplification process in Grover's Algorithm 550 is tuned to converge most effectively on feasible solutions. Alternatively, a randomized approach could be used if the fraction of valid solutions is not precisely known.

At step 556, measurement and post-processing is performed. The qubits are measured to obtain a recommended solution, where each solution is a set of routes. The measured solution is evaluated to verify it meets all field and logistical constraints. If multiple solutions are valid, each measurement can produce different feasible routes.

At step 557, adjustments and iterations are performed. If the solution obtained at step 556 is not fully feasible or optimal, refine the Oracle by lowering the cost threshold, and repeat steps 553 through 557 until the solution obtained at step 556 is fully feasible and optimal. This iterative approach accommodates dynamic changes in agricultural conditions or operational requirements.

Step 558 is final route selection and implementation. Once a valid and optimal solution is identified, translate the quantum-derived solution into actionable routing paths for the vehicles 10. The resulting optimized final route is returned to the main algorithm method 500, ready to be used for routing each vehicle 10.

### Generative AI-Enhanced Vehicle Routing Problem Solver 600 for Autonomous Agricultural Vehicle Path Planning

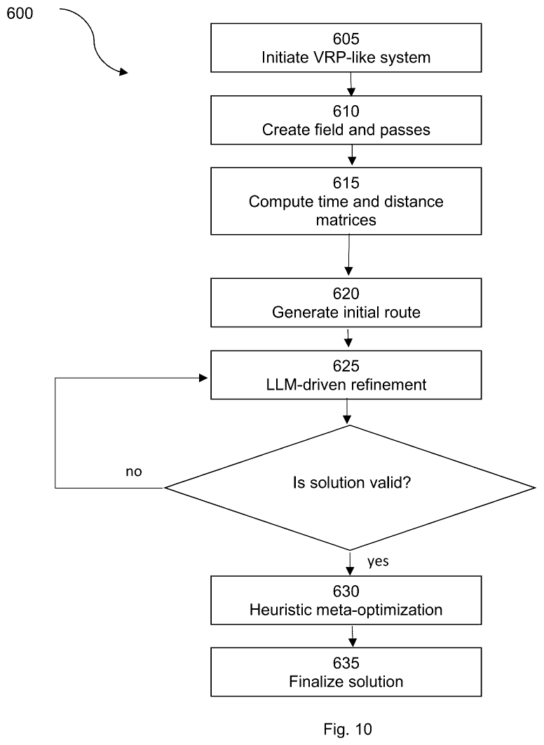

As shown in FIG. 10, a method for generative AI-enhanced vehicle routing problem 600 for one or more vehicles 10 is provided. The method for generative AI-enhanced vehicle routing problem 600 may alternatively be referred to as the generative AI-enhanced vehicle routing problem solver 600, method 600, or solver 600 without departing from the scope of the disclosure.

The method 600 significantly advances route optimization for autonomous agricultural vehicles 10 by combining traditional vehicle routing problem (VRP) algorithms with generative AI, specifically Large Language Model (LLM) reasoning. This novel hybrid approach tailors optimization strategies to the unique challenges of agriculture. The order of passes is optimized, refining how vehicles 10 sequence their passes through the field, ensuring minimal idle travel while respecting field geometry. LLM-assisted path planning is implemented by incorporating an LLM (GPT-based or comparable) to enhance decision-making. The LLM can be prompted with specific constraints such as time windows, fuel capacity, etc. to generate or refine candidate solutions. The method 600 handles multiple autonomous vehicles 10 simultaneously, assigning routes in an optimized manner that reduces overlap and ensures timely completion of tasks. The method 600 is also adaptable, adjusting to irregular field shapes, variable terrain, and dynamic operational constraints if needed.

A key feature of the method 600 is integration of custom time window constraints. The method 600 integrates custom time windows for each agricultural task, such as planting, harvesting, etc.). This ensures that tasks occur within their ideal timeframes to maximize yield and resource usage.

Another key feature of the method 600 is use of generative AI and hinting strategies. This feature involves chain of thought prompting. By prompting the LLM with smaller, more specific reasoning steps (for example, “Identify feasible next moves given, time and fuel constraints”), the system guides the AI to generate more accurate intermediate solutions. Visual and textual hints may be used. The LLM can optionally be presented with textual data (for example, “Collision hints,” “Free space hints,” “Prefix hints”) or minimal field maps. These hints are automatically generated by a solver that analyzes partial solutions and checks feasibility. An adaptive refinement loop may also be implemented. If an initial LLM proposal violates constraints, the system iteratively provides corrective hints (for example, “Node X intersects an obstacle”) and requests a revised solution.

Another key feature of the method 600 is use of dynamic constraints for agriculture. This feature may include terrain aware planning, in which distances and travel times between nodes are adjusted to account for varying field conditions. Dynamic constraints for agriculture may also involve fuel capacity management, in which routes must remain within the fuel limit of each vehicle 10, incorporating refueling strategies if needed. Dynamic constraints for agriculture may also involve vehicle 10 and implement 20 geometry considerations, which allows for specifying turning radii and tool widths, ensuring the path respects physical constraints in the field.

Another key feature of the method 600 is its unique optimization problem formulation, modeled as a multi-vehicle 10, non-convex variant of the VRP. The objective function can minimize (a) total distance, (b) total time, or (c) both total distance and total time, depending on the farm's operational priorities. Distance and time matrices are derived from realistic field metrics and vehicle 10 speed profiles.

Another key feature of the method 600 is heuristic and meta-heuristic solver integration. The solver 600 begins with a basic route solution derived from standard heuristics (e.g., nearest neighbor or sweep algorithm). The LLM is invoked to produce or refine routes, leveraging chain-of-thought prompting to detect collisions or suboptimal sequences. Techniques like simulated annealing, guided local search, or genetic algorithms further refine solutions, iterating until constraints are satisfied.

Another key feature of the method 600 is scalability and multi-vehicle 10 management. The method 600 efficiently handles large farms and multiple autonomous vehicles 10. The method 600 coordinates the route of each vehicle 10 to minimize idle time and overlapping passes. Real-time adjustments can be made if tasks change or unforeseen obstacles arise.

The method 600 for generative AI-enhanced vehicle routing problem begins at step 605 with initializing a VRP-like system configured to plan a route for one or more vehicles 10 through a work area. The VRP-like system incorporates field geometry, passes to cover, and constraints such as time, fuel and scheduling. The VRP-like system may comprise software running on monitor 30 or microprocessor 35. Alternately, the VRP-like system may execute on an external computer capable of communicating with the monitor 30 or microprocessor 35.

The method proceeds to step 610 in which a field and passes are created in the VRP-like system. The agricultural field to be covered by the method 600 is initialized, taking into account its unique shapes and sizes. Initializing the agricultural field to be covered at step 610 involves defining the boundaries of a working area of a field. The working area may be an entire field or a portion of a field. Defining the working area may be performed using several methods. For example, the agricultural field may be initialized by entering into path planning software the geospatial coordinates of points that, when connected, form the boundaries of the field, drawing the boundaries on a map using geospatial software, driving the perimeter of the working area and recording GPS coordinates of points defining the boundaries using the GPS unit 40, exporting geometries from other (FMIS) systems and importing those geometries into path planning software, or another method may be used without departing from the scope of the disclosure. The boundary of the working area is converted into discrete “passes (i.e., traversals across the field). Each pass end is treated as a node.

The method proceeds to step 615 in which a distance and time matrices are computed within the VRP-like system. To calculate the distance matrix, calculate the distance between every possible pair of nodes (ends of passes) created at step 610 to include direct distances for each pass, adapting this matrix to reflect the true distances encountered in agricultural settings due to varying terrains and pass lengths. Calculating the time matrix at step involves calculating the time required to travel between every possible pair of nodes (ends of passes), taking into account the direct distances for each pass and the velocity of the agricultural vehicle 10. In calculating the time and distance matrices, the physical realities of agricultural fields, such as terrain, and dynamics of the vehicle 10, including turning radius, implement width, and other factors, are accounted for. The core of the mathematical mode is the objective function. To formulate an optimization problem, redefine the problem as a multi-vehicle 10, non-convex optimization. Establish the number of vehicles 10 and their routes, incorporating the time and distance matrices computed at step 615, various constraints, and custom time windows. The objective function is formulated as one of the following four functions, and is selected based on the needs of the client and problem:

$$Minimize {\sum }_{-} ( i = 1 ) \hat{} n {\sum }_{-} ( j = 1 , j \neq i ) \hat{} n ( d\_ij * x\_ij + t\_ij * x\_ij )$$

$$or$$

$$Minimize {\sum }_{-} ( i = 1 ) \hat{} n {\sum }_{-} ( j = 1 , j \neq i ) \hat{} n ( d\_ij * x\_ij )$$

$$or$$

$$Minimize {\sum }_{-} ( i = 1 ) \hat{} n {\sum }_{-} ( j = 1 , j \neq i ) \hat{} n ( t\_ij * x\_ij )$$

where d_ij represents the distance between nodes i and j, t_ij represents the travel time from i to j, and x_ij is a binary variable indicating whether the path from i to j is included in the route of the vehicle 10.

At step 620, an initial or preliminary route is generated by the VRP-like system using classical heuristics (e.g., nearest neighbor).

At step 625, LLM-driven refinement is performed. A prompt is generated using a prompt template that includes field geometry, pass sequences, known collisions, feasible sub-paths, and constraints. The initial route generated at step 620 also incorporated into the prompt template. Applicable constraints and any relevant hints, such as collision points and feasible sub-paths, are also provided to the LLM in the prompt. Prompt hints may include prefix hints, for example, “Partially valid routes that meet constraints so far,” or time window hints, for example, “Pass X must be done before time Y.” Several constraints of various types may be applied, reflecting the operational realities encountered by vehicle 10 during a work operation. The constraints may include time window constraints, constraints to ensure complete coverage of the field, and any other scheduling, resource, or capacity constraints. The method 600 incorporates time-window constraints essential for the sequential execution of various farming tasks such as tillage, planting, weeding, harvesting etc. By optimizing the order and timing of field operations, the solution provided by the method 600 ensures that each activity is performed within its ideal and assigned timeframe. Another type of constraint involves ensuring that each pass is worked exactly once, which is represented mathematically to prevent redundant coverage and guarantee total field service. While each pass must be worked exactly once during the work operation, meaning that the field operation being performed is only done once to a particular pass, the optimizer may choose to traverse a pass more than once. Another type of constraint involves applying fuel constraints, including fuel capacity limitations ensuring that planned routes do not exceed the fuel capacity of the vehicles 10, necessitating returns to a depot or fuel station. For a planting operation, the constraints may include the amount of seed held by the planter/implement 20. For a spraying operation, the constraints may include the amount of chemicals stored in the sprayer/implement 20. Any similar scheduling, resource, or capacity constraints may be implemented without departing from the scope of the disclosure. The LLM's solution or route refinement is received back by the VRP-like system, and the VRP-like system validates the LLM's output with a collision checker or satisfiability solver. If the solution or route refinement provided by the LLM is invalid, the LLM is re-prompted with targeted hints. Re-prompting is adaptive, meaning that when an LLM solution violates constraints, a solver generates corrective hints and re-queries the LLM. Step 625 is repeated as needed until a valid solution is found, and the method 600 then proceeds to step 630. The distance and time matrices calculated at step 615 may be adjusted after each LLM-driven or solver-driven iteration if new constraints arise, for example, weather conditions or obstacles, In the solution validation and optimization steps, feasibility of a solution is confirmed using a constraint checker or satisfiability module theory (SMT) solver. Iterations are performed until the constraints are satisfied or no feasible solution can be found.

At step 630, heuristic meta-optimization is performed. To solve the optimization problem at step 630, employ heuristic and meta-heuristic techniques, such as guided local search and simulated annealing. These methods start with a simplistic initial solution considering basic route logic and constraints, then iteratively improve this initial solution using a solver guided local search strategies and other techniques like simulated annealing to find more efficient routing combinations.

At step 635, the solution is finalized. Upon convergence, the system outputs an optimized set of routes and recommended order of passes for each vehicle 10. The method 600 ensures they are aligned with the operational efficiencies, time requirements, and resource constraints of modern agricultural practices. For example, time windows and fuel constraints must be adhered to, and the chosen objective (distance, time, or a combination) must be minimized. The final paths are constructed based on the optimized order of passes from the start point to the end point of the plan. The optimized order of passes and final path plan are returned, and the complete path plan can then be implemented by the vehicle 10.

The method 600 provides a substantial leap in performance and adaptability over conventional methods, ensuring routes are generated with deeper contextual reasoning, faster adaptation to new constraints, and superior resource efficiency in agricultural operations. LLMs are used not just as static solvers but as adaptive agents capable of contextual reasoning across spatial, temporal and resource domains. The result is a system that outperforms traditional planners in flexibility, speed of adaptation to new constraints and the ability to handle complex interdependent agricultural tasks.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for optimizing a route for execution by a system that controls one or more agricultural vehicles comprising:
defining an area of land to be worked by the one or more agricultural vehicles;
creating a plurality of passes that completely cover the area of land, wherein each pass comprises a first end and a second end;
transforming each first end and each second end of each of the plurality of passes into a plurality of nodes;
connecting the plurality of nodes to create one or more possible routes;
computing a distance matrix by calculating distances between every possible pair of nodes for each of the one or more possible routes;
computing a time matrix by calculating times required to travel between every possible pair of nodes for each of the one or more possible routes; the time and distance matrix does not have to be computed in any particular order applying constraints configured to ensure that each of the plurality of passes is worked exactly once by the one or more agricultural vehicles and also configured to ensure that time window requirements are met;
formulating a non-convex optimization problem incorporating the distance matrix, the time matrix, the constraints, and the time window requirements, the non-convex optimization problem having one or more solutions;
determining that a feasible solution to the non-convex optimization problem exists; and
solving the non-convex optimization problem using quantum annealing for agricultural vehicle routing to create an optimized route for controlling the one or more agricultural vehicles.

2. The method of claim 1 wherein connecting the plurality of nodes to create routes comprises connecting the plurality of nodes with Dubins paths.

3. The method of claim 1 wherein connecting the plurality of nodes to create routes comprises accommodating a turn radius, a speed, an implement, a time to raise the implement, and a time to lower the implement associated with the vehicle.

4. The method of claim 1 wherein applying constraints further comprises integrating fuel capacity limits of the vehicle.

5. The method of claim 1 further comprising determining that a feasible solution to the non-convex optimization problem does not exist, adjusting the constraints configured to ensure that each of the plurality of passes is worked exactly once by the one or more agricultural vehicles and also configured to ensure that time window requirements are met to create adjusted constraints, and reformulating the non-convex optimization problem with the adjusted constraints before determining that a feasible solution to the non-convex optimization problem exists.

6. The method of claim 1 wherein using quantum annealing for agricultural vehicle routing comprises formulating a quadratic unconstrained binary optimization matrix having a cost function incorporating distance, time, and agricultural constraints; loading the quadratic unconstrained binary optimization matrix into a quantum annealer, performing quantum annealing on the quadratic unconstrained binary optimization matrix to create one or more resulting quantum states, determining an energy level for each of the resulting quantum states, selecting as an optimized solution a resulting quantum state having an energy level lower than any other resulting quantum state.

7. The method of claim 6 further comprising verifying that the optimized solution meets agricultural and routing constraints.

8. The method of claim 6 further comprising determining that the optimized solution is not feasible, adjusting the quadratic unconstrained binary optimization matrix, and repeatedly performing quantum annealing to determine a final route.

9. A method for optimizing a route for execution by a system that controls one or more agricultural vehicles comprising:
defining an area of land to be worked by the one or more agricultural vehicles;
creating a plurality of passes that completely cover the area of land, wherein each pass comprises a first end and a second end;
transforming each first end and each second end of each of the plurality of passes into a plurality of nodes;
connecting the plurality of nodes to create one or more possible routes;
computing a distance matrix by calculating distances between every possible pair of nodes for each of the one or more possible routes;
computing a time matrix by calculating times required to travel between every possible pair of nodes for each of the one or more possible routes;
applying constraints configured to ensure that each of the plurality of passes is worked exactly once by the one or more agricultural vehicles and also configured to ensure that time window requirements are met;
formulating a non-convex optimization problem incorporating the distance matrix, the time matrix, the constraints, and the time window requirements, the non-convex optimization problem having one or more solutions;
determining that a feasible solution to the non-convex optimization problem exists; and
solving the non-convex optimization problem to create an optimized route for controlling the one or more agricultural vehicles.

10. The method of claim 9 wherein connecting the plurality of nodes to create routes comprises connecting the plurality of nodes with Dubins paths.

11. The method of claim 9 wherein connecting the plurality of nodes to create routes comprises accommodating a turn radius, a speed, an implement, a time to raise the implement, and a time to lower the implement associated with the vehicle.

12. The method of claim 9 wherein applying constraints further comprises integrating fuel capacity limits of the vehicle.

13. The method of claim 9 further comprising determining that a feasible solution to the non-convex optimization problem does not exist, adjusting the constraints configured to ensure that each of the plurality of passes is worked exactly once by the one or more agricultural vehicles and also configured to ensure that time window requirements are met to create adjusted constraints, and reformulating the non-convex optimization problem with the adjusted constraints before determining that a feasible solution to the non-convex optimization problem exists.

14. The method of claim 9 wherein solving the non-convex optimization problem comprises employing heuristic and meta-heuristic techniques.

15. A method for optimizing a route for execution by a system that controls one or more agricultural vehicles comprising:
defining an area of land to be worked by the one or more agricultural vehicles;
creating a plurality of passes that completely cover the area of land, wherein each pass comprises a first end and a second end;
transforming each first end and each second end of each of the plurality of passes into a plurality of nodes;
connecting the plurality of nodes to create one or more possible routes;
computing a distance matrix by calculating distances between every possible pair of nodes for each of the one or more possible routes;
computing a time matrix by calculating times required to travel between every possible pair of nodes for each of the one or more possible routes; the time and distance matrix does not have to be computed in any particular order applying constraints configured to ensure that each of the plurality of passes is worked exactly once by the one or more agricultural vehicles and also configured to ensure that time window requirements are met;
formulating a non-convex optimization problem incorporating the distance matrix, the time matrix, the constraints, and the time window requirements, the non-convex optimization problem having one or more solutions;
determining that a feasible solution to the non-convex optimization problem exists; and
solving the non-convex optimization problem using Grover's Algorithm to create an optimized route for controlling the one or more agricultural vehicles.

16. The method of claim 15 wherein connecting the plurality of nodes to create routes comprises connecting the plurality of nodes with Dubins paths.

17. The method of claim 15 wherein connecting the plurality of nodes to create routes comprises accommodating a turn radius, a speed, an implement, a time to raise the implement, and a time to lower the implement associated with the vehicle.

18. The method of claim 15 wherein applying constraints further comprises integrating fuel capacity limits of the vehicle.

19. The method of claim 15 further comprising determining that a feasible solution to the non-convex optimization problem does not exist, adjusting the constraints configured to ensure that each of the plurality of passes is worked exactly once by the one or more agricultural vehicles and also configured to ensure that time window requirements are met to create adjusted constraints, and reformulating the non-convex optimization problem with the adjusted constraints before determining that a feasible solution to the non-convex optimization problem exists.
